(19) United States
(12) Patent Application Publication
(10) Pub. No.: US 2015/0102614 A1
(43) Pub. Date: Apr. 16, 2015

(54) BUMPER CROSSBEAM FOR A MOTOR VEHICLE

(71) Applicant: Benteler Automobiltechnik GmbH, Paderborn (DE)

(72) Inventor: Wilhelm Arns, Paderborn (DE)

(21) Appl. No.: 14/509,490

(22) Filed: Oct. 8, 2014

(30) Foreign Application Priority Data
Oct. 10, 2013 (DE) 10 2013 111 189.0

(51) Int. Cl. B60R 19/02; B60R 19/18

(52) U.S. Cl. CPC B60R 19/023; B60R 19/18; B60R 2019/1813
USPC 293/102

(57) ABSTRACT

A bumper crossbeam for a motor vehicle includes a shell-shaped longitudinal member having an upper leg and a lower leg. A face plate is arranged on an open side of the longitudinal member and configured to connect the upper and lower legs of the longitudinal member at joints disposed in a longitudinal direction of the longitudinal member in spaced-apart relationship along an upper longitudinal edge and a lower longitudinal edge of the face plate. Openings are provided between the joints such that the openings along the upper longitudinal edge and the openings along the lower longitudinal edge are arranged in staggered relationship.

### CROSS-REFERENCES TO RELATED APPLICATIONS

This application claims the priority of German Patent Application, Serial No. 10 2013 111 189.0, filed Oct. 10, 2013, pursuant to 35 U.S.C. 119(a)-(d), the disclosure of which is incorporated herein by reference in its entirety as if fully set forth herein.

### BACKGROUND OF THE INVENTION

The present invention relates to a bumper crossbeam for a motor vehicle.

The following discussion of related art is provided to assist the reader in understanding the advantages of the invention, and is not to be construed as an admission that this related art is prior art to this invention.

Bumpers are usually installed across the front and rear sides of a motor vehicle to absorb impact energy in the event of smaller impacts and to thereby prevent as much damage as possible to the actual support structure of the motor vehicle. A typical bumper includes a bumper crossbeam which can be mounted via crash boxes transversely to the side rails of the motor vehicle frame. The bumper crossbeam directs hereby energy caused by an impact into the crash boxes where the impact energy is converted into the deformation work.

Bumpers have to be constructed to satisfy legal provisions and demands by consumer protection agencies in terms of pedestrian protection. Moreover, bumpers have to meet classification tests of insurance companies (RCAR, GDV). Also automakers demand bumper configurations that allow optimum space utilization, easy installation, maximum energy absorption, and are lightweight as well as economically viable. In particular the desired reduction in CO₂ emission requires lightweight construction when designing vehicles.

U.S. Pat. No. 8,622,446 describes a bumper crossbeam having a hat profile and a face plate to close the open side of the hat profile of the crossbeam. The face plate is hereby welded to the crossbeam at spaced-apart joints. In the regions between the joints, crevice corrosion can occur that adversely affects the properties of the bumper.

It would therefore be desirable and advantageous to provide an improved bumper crossbeam which obviates prior art shortcomings and which has less tendency to corrode and lightweight.

### SUMMARY OF THE INVENTION

According to one aspect of the present invention, a bumper crossbeam for a motor vehicle includes a shell-shaped longitudinal member having an upper leg, a lower leg, and a face plate arranged on an open side of the longitudinal member and configured to connect the upper and lower legs of the longitudinal member at joints disposed in a longitudinal direction of the longitudinal member in spaced-apart relationship along an upper longitudinal edge and a lower longitudinal edge of the face plate, with openings being provided between the joints such that the openings along the upper longitudinal edge and the openings along the lower longitudinal edge are arranged in staggered relationship.

The term “joint” as used in the specification relates to an individual welding spot or soldering spot. Of course, each joint may involve also two or more such welding spots or soldering spots. In addition, the term “joint” covers also a short welded seam or soldered seam.

In accordance with the present invention, the provision of openings allows a cutting of the face plate between the joints to such an extent that a gap is formed sufficient to allow painting. There is no need for punching of the face plate to produce a paintable gap. The openings provide locations where the bumper crossbeam can be reliably painted. This reduces corrosion and, moreover, the overall weight of the bumper crossbeam is reduced. The staggered arrangement of the openings along the upper longitudinal edge and the openings along the lower longitudinal edge results in superior material use of sheet metal material, when several face plates should be cut from a large metal sheet blank or when strip material is withdrawn from a metal sheet coil. Also, the force flux and bending behavior are positively affected. In other words, the bumper crossbeam does not twist or only insignificantly gets twisted, when acted upon by an asymmetric bending force.

According to another advantageous feature of the present invention, the upper leg and the lower leg can each have an end extended by a flange. The flanges are directed transversely to the legs and can point from the legs outwards or inwards. Currently preferred is a configuration of the shell-shaped longitudinal member in which the flanges project outwards. The face plate bears upon the flanges via the joints and is joined there in the region of the joints with the bumper crossbeam. The face plate is cut out to provide the openings in the area between the joints. In the absence of such flanges, the face plate bears upon the free ends of the legs and is joined with the free ends of the legs. Openings are provided between the joints along the upper longitudinal edge and the lower longitudinal edge of the face plate.

According to another advantageous feature of the present invention, the openings have each an inner edge portion which can demarcate a gap with the upper and lower legs, respectively. The inner edge portion of an opening thus does not touch the legs or flanges along the legs. This advantageously assists paintability and prevents corrosion.

Advantageously, the openings are sized greater than joining surfaces of the joints. Thus, the surface area of an opening is sized greater than the surface area of a neighboring joining surface of a joint.

According to another advantageous feature of the present invention, the face plate can have at least one depression. In this way, stiffness of the face plate can be adjusted. A depression may be provided in a central length portion of the face plate. The depression may be configured as longitudinal depression. Such a longitudinal depression extends in length direction of the bumper crossbeam, in particular across the central length portion, advantageously over a length of about one third of the bumper crossbeam or face plate. Of course, the presence of several depressions in parallel relationship is also conceivable. Conceivable is also the embossment of both longitudinal depressions and vertical depressions in the face plate.

According to another advantageous feature of the present invention, the face plate can have at least one cup-shaped boss and/or a through-passage. Bosses or through-passages are provided to best suit the bending and stress behavior of the bumper crossbeam at hand. A through-passage may also be used for feedthrough of a tow sleeve or tow lug.

According to another advantageous feature of the present invention, the face plate can have a hat-shaped cross section. The face plate has openings, e.g. rectangular openings at the longitudinal edges. The hat-shaped configuration improves pedestrian protection because of the resilient and/or elastically yielding behavior of the face plate.

According to another advantageous feature of the present invention, the face plate can have at least one area or be fully formed of struts in zigzag configuration. The struts serve as tensile struts and connect the upper leg and the lower leg of the longitudinal member. The joints are formed by transition zones between the struts. The free spaces between the joints respectively form the openings between the struts that are arranged slantingly relative to one another. The openings can be configured triangular in shape or V-shaped and extend from an upper transition zone to the transition zone of the opposing lower leg.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a top, front and side perspective view of a bumper with a first embodiment of a bumper crossbeam according to the present invention;

FIG. 2 is a front view of the bumper crossbeam of FIG. 1;

FIG. 3 is a plan view of the bumper crossbeam of FIG. 1;

FIG. 4 is a vertical cross sectional perspective view of the bumper crossbeam of FIG. 1;

FIG. 5 is a front view of a second embodiment of a bumper crossbeam according to the present invention;

FIG. 6 is a front view of a third embodiment of a bumper crossbeam according to the present invention;

FIG. 7 is a front view of a fourth embodiment of a bumper crossbeam according to the present invention;

FIG. 8 is a front view of a face plate of the bumper crossbeam of FIG. 7;

FIG. 9 is a simplified, schematic illustration of another embodiment of a face plate for a bumper crossbeam according to the present invention;

FIG. 10 is a top, front and side perspective view of a bumper with a fifth embodiment of a bumper crossbeam according to the present invention;

FIG. 11 is a schematic illustration of a cutting pattern for the production of face plates from a metal strip reeled off a coil;

FIG. 12 is a top, front and side perspective view of a bumper with a sixth embodiment of a bumper crossbeam according to the present invention; and

FIG. 13 is a front view of the bumper crossbeam of FIG. 12.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

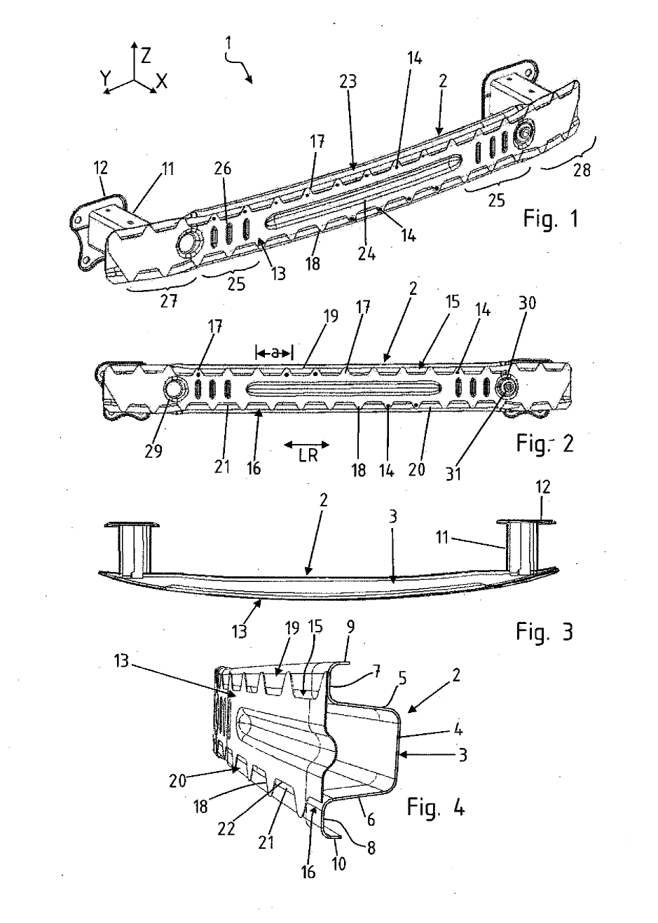

Turning now to the drawing, and in particular to FIG. 1, there is shown a top, front and side perspective view of a bumper, generally designated by reference numeral 1 and installed across the front or rear of a body (not shown) of a motor vehicle (not shown). The bumper 1 is provided with a first embodiment of a bumper crossbeam 2 according to the present invention. The bumper crossbeam 2 includes a longitudinal member 3 which is open on one side and is configured generally U-shaped, as best seen in FIG. 4. The longitudinal member 3 has a central web 4 which is oriented vertically in the drawing plane and extends between a first upper leg 5 and a second lower leg 6. The legs 5, 6 have each an end which is extended by an outwardly directed flange 7 and 8. Each flange 7, 8, in turn, is extended by an end web 9, 10 directed in the direction of the web 4.

As best seen in FIG. 3, the bumper crossbeam 2 is supported at the left-hand side and the right-hand side thereof in the region of its ends via crash boxes 11 and touch plates 12 to side rails of the motor vehicle frame and connected therewith.

Provided at the open side of the longitudinal member 3 is a face plate 13 to connect the upper leg 5 and the lower leg 6. The face plate 13 is joined with the upper leg 5 and the lower leg 6 at joints 14 which are spaced from one another in length direction LR of the longitudinal member 3 by a distance a, as shown in FIG. 2. The joints 14 are welding and/or soldering spots and shown in FIGS. 1 and 2 by way of example. The face plate 13 has joining surfaces 17, 18 in the region of the joints 14 along its upper longitudinal edge 15 and along its lower longitudinal edge 16. The joining surfaces 17, 18 are formed by triangular sheet metal tabs. Openings 19, 20 are provided between the joining surfaces 17, 18. The face plate 13 is cut free between the joints 14 in the region of the openings 19, 20 to such an extent as to establish a paintable gap 21. The openings 19, 20 ensure a reliable paintability of the bumper crossbeam 2. As a result, corrosion susceptibility is decreased, especially against crevice corrosion. Moreover, the presence of the openings 19, 20 reduces the weight of the face plate 13 and overall the weight of the bumper crossbeam 2.

FIG. 4 shows in particular the formation of the gap 21 between an inner edge portion 22 of an opening 19, 20, extending in length direction LR of the face plate 13, and the respective leg 5, 6 or flange 7, 8 of the longitudinal member 3. In other words, the face plate 13 and the longitudinal member 3 do not touch one another in this region. The gap 21 is open.

As is readily apparent from FIG. 2, the openings 19 along the upper longitudinal edge 15 and the openings 20 along the lower longitudinal edge 16 are arranged in horizontal staggered or offset relationship. This is beneficial in terms of manufacture because the cutting pattern can be guided such that a starting blank can be effectively utilized. This further contributes to an improvement of the bending and stress behavior of the bumper 1.

The face plate 13 is provided in the central length portion 23 with a longitudinal depression 24, as can be seen in FIG. 1. The longitudinal depression 24 extends in length direction LR of the bumper crossbeam 2 or the face plate 13 along the entire central length portion 23. Extending the central length portion 23 to the left and right in length direction LR are length portions 25, respectively, which are formed with vertical depressions 26 that extend in motor vehicle z direction. Adjacent to the length portions 25 are end portions 27, 28, respectively, which are each provided with a through-passage 29, 30 (FIG. 2). Integrated in the through-passage 30 on the right-hand side of the drawing plane is a tow sleeve 31.

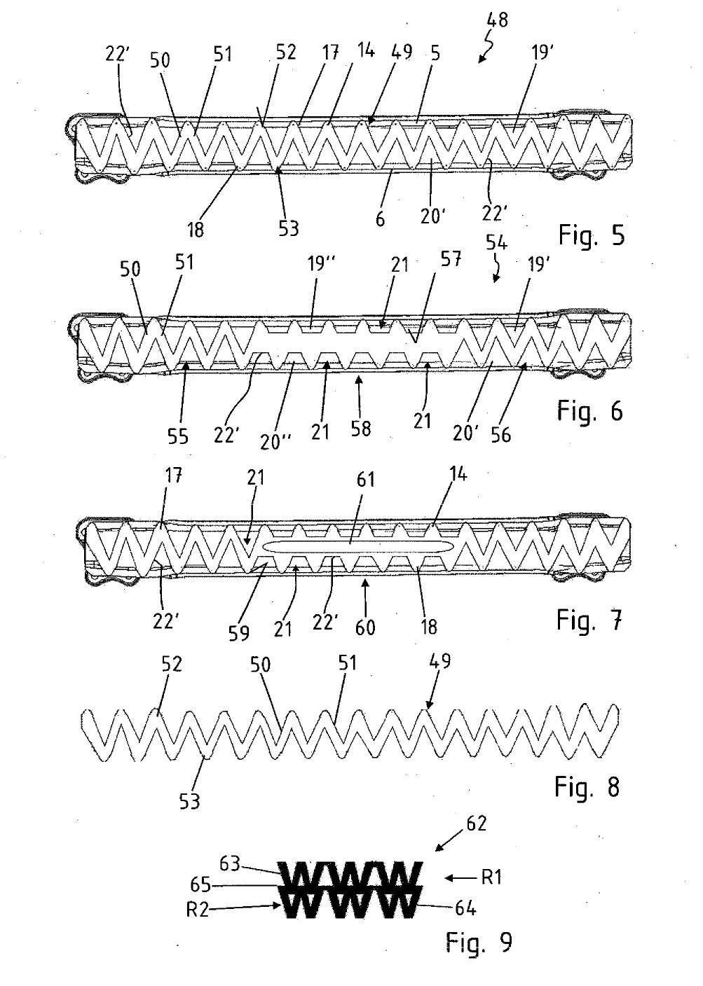

Turning now to FIG. 5, there is shown a second embodiment of a bumper crossbeam according to the present invention, generally designated by reference numeral 48. Parts corresponding with those in FIGS. 1-4 are denoted by identical reference numerals and not explained again. The description below will center on the differences between the embodiments. In this embodiment, provision is made for a face plate 49 which is formed by an alternating sequence of struts 50, 51 which extend in a zigzag configuration and are oriented slantingly relative to one another at an angle. The struts 50, 51 serve as braces and connect the upper leg 5 and the lower leg 6 of the longitudinal member 3. The face plate 49 is joined with the upper and lower legs 5, 6 via joints 14 in a transition zone 52, 53 between adjacent struts 50, 51. The transition zones 52, 53 form joining surfaces 17, 18, with openings 19′, 20′ being provided between the joining surfaces 17, 18. Reference sign 22′ designates inner edge portions 22′ of the struts 50, 51. The inner edge portion 22′ bound the openings 19′, 20′.

FIG. 8 shows a front view of the face plate 49 separately for illustrative purposes.

FIG. 6 is a front view of a third embodiment of a bumper crossbeam according to the present invention, generally designated by reference numeral 54. In this embodiment, provision is made for a face plate 57 which has left and right end portions 55, 56 formed by struts 50, 51 in zigzag configuration. In the central length portion 58 between the end portions 55, 56, the face plate 57 is configured more solid, i.e. the opening 19″, 20″ between adjacent joining surfaces 17, 18 are cut more shallow in these regions compared to the openings 19′, 20′ in the left and right end portions 55, 56, respectively.

FIG. 6 further shows the presence of gap 21 between the inner edge portion 22′ of an opening 19′, 20′ and the legs 5, 6 and flanges 7, 8, respectively.

FIG. 7 shows a modification of the bumper crossbeam of FIG. 6. In this embodiment, provision is made for a face plate 59 which substantially corresponds to the face plate 57 of FIG. 6, except for the presence of a longitudinal depression 61 in the central length portion 60 of the face plate 59 to stiffen the central length portion 60.

FIG. 9 shows a simplified, schematic illustration of another embodiment of a face plate, generally designated by reference numeral 62, for a bumper crossbeam. The face plate 62 is formed by two rows R1, R2 of struts 63, 64 which are placed above one another and have zigzag configuration or V-shaped configuration. The struts 63, 64 are connected to one another by a central longitudinal strut 65.

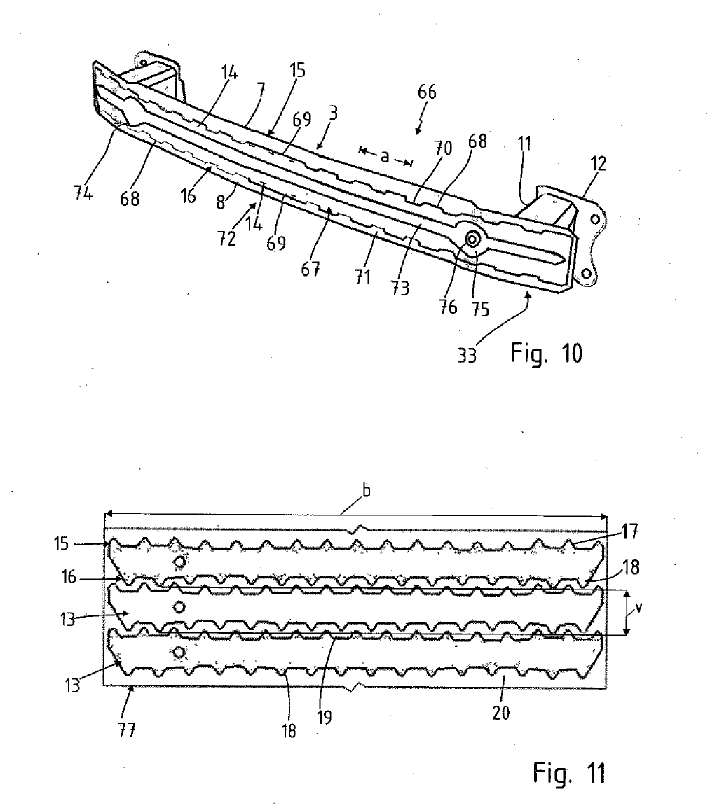

Referring now to FIG. 10, there is shown a top, front and side perspective view of a bumper, generally designated by reference numeral 66 and including a bumper crossbeam 33 having a longitudinal member 3 which is open on one side and is configured generally U-shaped with an upper leg and a lower leg, not visible here. A face plate 67 is placed upon the open side of the longitudinal member 3 and connects the upper and lower legs. Upper flange 7 extends from an end of the upper leg and lower flange 8 extends from an end of the lower leg. The face plate 67 is joined with the legs or flanges 7, 8 at joints 14 which are spaced from one another in length direction LR of the longitudinal member 3 by a distance a. The face plate 67 has joining surfaces 68, 69 in the region of the joints 14 along its upper longitudinal edge 15 and along its lower longitudinal edge 16. Openings 70, 71 are provided between the joining surfaces 68, 69. In the face plate 67, the joining surfaces 69 in the central length portion 72 of the face plate 67 are configured longer than the remaining joining surfaces 68. The joints 14 may be laser welding seams or arc welds. Provision may also be made for a short welding seam or soldering seam in the central length portion 72.

As is readily apparent from FIG. 10, the openings 70 along the upper longitudinal edge 15 and the openings 71 along the lower longitudinal edge 16 are arranged in horizontal staggered relationship. The joining surfaces 68, 69 have a rectangular or trapezoidal configuration, with the openings 70, 71 arranged between the joining surfaces 68, 69 along the upper and lower longitudinal edges 15, 16 also configured of rectangular or trapezoidal shape.

FIG. 10 also shows that the face plate 67 is formed with a longitudinal depression 73 which extends substantially across the entire length of the face plate 67. In addition, the face plate 67 is formed with a cup-shaped boss 74, 75 in the region of each of the crash boxes 11 on the left-hand side and right-hand side. A sleeve 76 is provided in the boss 75 on the right-hand side of the drawing plane and has an internal thread for receiving a tow lug.

FIG. 11 shows a schematic illustration of a cutting pattern for a punching process of face plates, e.g. face plates 13, from a metal strip 77 reeled off a coil. The width of the metal strip 77 is designated by reference character b. As a result of the staggered arrangement of the joining surfaces 17, 18 at the upper longitudinal edge 15 and the lower longitudinal edge 16 of a face plate 13, the joining surface 17 at the upper longitudinal edge 15 is located in an opening 20 of the lower longitudinal edge 16, and vice versa. Through suitable feed control, the punch cuts are executed, using the available material in an optimal manner in terms of manufacture. The feed or advance is indicated in FIG. 11 by the measure v.

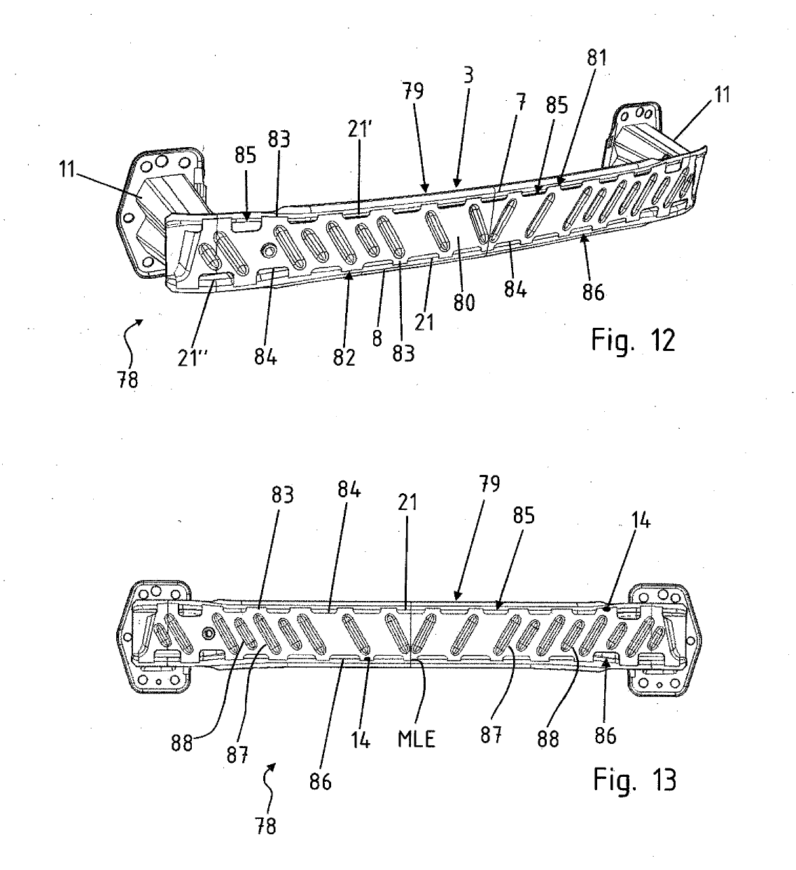

FIG. 12 shows a top, front and side perspective view of another embodiment of a bumper crossbeam according to the present invention, generally designated by reference numeral 79, of a bumper 78. The bumper crossbeam 79 extends transversely between the crash boxes 11 and is substantially formed by a shell-shaped longitudinal member 3 with an upper leg 5 and a lower leg 6, which are extended at their ends by outwardly directed flanges 7, 8 along the length of the longitudinal member 3. Provided at the open side of the bumper crossbeam 79 or longitudinal member 3 is a face plate 80 to connect the upper leg and the lower leg. The face plate 80 has joining surfaces 83 along its upper longitudinal edge 81 and along its lower longitudinal edge 82. The joining surfaces 83 have a tab-like configuration and project beyond the inner edge portions 84 of the face plate 80. The face plate 80 bears with the joining surfaces 83 upon the flanges 7, 8 and is joined there via joints 14. Openings 85, 86 are provided between the joining surfaces 83 along the upper longitudinal edge 81 and along the lower longitudinal edge 82. The openings 85, 86 are dimensioned such that a gap 21, 21′, 21″ is established between the face plate 80 or the inner edge portions 84 and the legs 5, 6 or flanges 7, 8. The openings 85, 86 assist in the implementation of a surface coating of the bumper crossbeam 79, especially ensure a reliable paintability of the bumper crossbeam 79. Moreover, the presence of the openings 85, 86 reduces the weight of the bumper crossbeam 79.

As is readily apparent from FIG. 13, which is a front view of the bumper crossbeam 79, the face plate 80 is formed with depressions 87, 88 which are directed slantingly or diagonally and in part of different lengths. The depressions 87, 88 are mirror images of one another with respect to the vertical longitudinal center axis MLE. The depressions 87, 88 of the face plate 80 on the left-hand side and the depressions 87, 88 of the face plate 80 on the right-hand side are slanted in opposite directions.

As further shown in FIG. 13, the openings 85 along the upper longitudinal edge 81 and the openings 86 along the lower longitudinal edge 82 of the face plate 80 are arranged staggered to one another.

Common to all embodiments described herein is that the joining surface is greater than the area of an opening.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A bumper crossbeam for a motor vehicle, comprising:
a shell-shaped longitudinal member having an upper leg and a lower leg; and
a face plate arranged on an open side of the longitudinal member and configured to connect the upper and lower legs of the longitudinal member at joints disposed in a longitudinal direction of the longitudinal member in spaced-apart relationship along an upper longitudinal edge and a lower longitudinal edge of the face plate, with openings being provided between the joints such that the openings along the upper longitudinal edge and the openings along the lower longitudinal edge are arranged in staggered relationship.

2. The bumper crossbeam of claim 1, wherein the upper leg has an end extended by a flange and the lower leg has an end extended by a flange.

3. The bumper crossbeam of claim 2, wherein the face plate is joined to the flanges of the upper and lower legs.

4. The bumper crossbeam of claim 1, wherein the openings have each an inner edge portion demarcating a gap with the upper and lower legs, respectively.

5. The bumper crossbeam of claim 1, wherein the face plate has at least one depression.

6. The bumper crossbeam of claim 1, wherein the face plate has at least one cup-shaped boss or a through passage.

7. The bumper crossbeam of claim 1, wherein the face plate has a hat-shaped cross section.

8. The bumper crossbeam of claim 1, wherein the face plate has at least one area formed of struts in zigzag configuration.

9. The bumper crossbeam of claim 1, wherein the openings define each a surface area which is greater than a surface area of a joining surface of an adjacent one of the joints.
